(19) United States
(12) Patent Application Publication
(10) Pub. No.: US 2022/0067445 A1
(43) Pub. Date: Mar. 3, 2022

(54) SYSTEMS AND METHODS FOR AUTOMATED CLASSIFICATION OF SIGNAL DATA SIGNATURES

(71) Applicant: Covid Cough, Inc., Greenwood Village, CO (US)

(72) Inventors: Michelle Archuleta, Lakewood, CO (US); Morgan Cox, Lakewood, CO (US); Nolan Donaldson, Denver, CO (US); Adam Stogsdill, Cypress, TX (US); Simon Kotchou, Phoenix, AZ (US); Maurice A. Ramirez, Lake Wales, FL (US)

(21) Appl. No.: 17/465,399

(22) Filed: Sep. 2, 2021

Related U.S. Application Data
(60) Provisional application No. 63/073,962, filed on Sep. 3, 2020.

(51) Int. Cl. G06K 9/62; G06N 3/08

(52) U.S. Cl. CPC G06K 9/6262; G06K 9/6234; G06N 3/088

(57) ABSTRACT

Systems and methods of the present disclosure enable automated detection of signal data signatures by receiving a first reward and a first state including a signal data signature recording having a first onset location and a first offset location. An action is performed to produce a second state with second onset and offset locations based on the first state, the first reward and a policy of a reinforcement learning agent. A discriminator machine learning model determines a match score representative of a similarity between the second state and a target distribution of a signal data signature type. A second reward is determined based on the match score and, based on the second reward exceeding a threshold, a modified signal data signature recording is produced with the signal data signature having a modified beginning and a modified end according to the second onset location and the second offset location, respectively.

### CROSS-REFERENCE TO RELATED APPLICATIONS

This application claims priority to U.S. Provisional Application 63/073,962, titled “GENERATIVE ADVERSERIAL NETWORKS AS AN ORACLE FOR REINFORCEMENT LEARNING TO CLASSIFY SOUND” and filed Sep. 3, 2020, which is hereby incorporated by reference in its entirety.

### TECHNICAL FIELD

The present invention relates generally to Artificial Intelligence and specifically to reinforcement learning and generative adversarial learning for signal data signature classification. In particular, the present invention is directed to signal data signature event detection, signal data signature classification, utilizing generative adversarial networks and reinforcement learning. In particular, it relates to generalizable reward mechanisms for reinforcement learning such that the reward mechanism is derived from the underlying distribution of signal data signatures used to train a generative adversarial network.

### BACKGROUND ART

The prior art is limited by software programs that require human input and human decision points, algorithms that fail to capture the underlying distribution of signal data signature, algorithms that are brittle and unable to perform well on datasets that were not present during training.

### SUMMARY OF THE DISCLOSURE

Signal data signature Event Detection is the task of recognizing signal data signature events and their respective temporal start and end time in a signal data signature recording. Signal data signature event detection aims at processing the continuous acoustic signal and converting it into symbolic descriptions of the corresponding signal data signature events as well as the timing of those events. Signal data signature event detection has many different commercial applications such as context-based indexing, retrieval in multimedia databases, unobtrusive monitoring in health care, surveillance, and medical diagnostics.

The unmet need is to classify and tag signal data signatures. The unmet need would only be accomplished with a signal data signature detection system that consists of hardware devices (e.g. desktop, laptop, servers, tablet, mobile phones, etc.), storage devices (e.g. hard drive disk, floppy disk, compact disk (CD), secure digital card, solid state drive, cloud storage, etc.), delivery devices (paper, electronic display), a computer program or plurality of computer programs, and a processor or plurality of processors. A signal data signature detection system when executed on a processor (e.g. CPU, GPU) would be able to identify a signal data signature such as a Covid-19 cough from other types of cough and/or signal data signature and delivered to clinicians and/or end-users through a delivery device (paper, electronic display).

### BRIEF DESCRIPTION OF THE DRAWINGS

Various embodiments of the present disclosure can be further explained with reference to the attached drawings, wherein like structures are referred to by like numerals throughout the several views. The drawings shown are not necessarily to scale, with emphasis instead generally being placed upon illustrating the principles of the present disclosure. Therefore, specific structural and functional details disclosed herein are not to be interpreted as limiting, but merely as a representative basis for teaching one skilled in the art to variously employ one or more illustrative embodiments.

FIG. 1 illustrates a signal data signature signal data signature detection system.

FIG. 2 depicts a reinforcement learning system.

FIG. 3 illustrates a reinforcement learning system with detailed components of the oracle, generative adversarial network (GAN).

FIG. 4 illustrates transfer learning between the generative model, GAN, and the discriminative model function approximator.

FIG. 5 depicts a block diagram of an exemplary computer-based system and platform 500 for a signal data signature detection system 100 according to aspects of embodiments of the present disclosure.

FIG. 6 depicts a block diagram of another exemplary computer-based system and platform 600 for a signal data signature detection system 100 according to aspects of embodiments of the present disclosure.

FIG. 7 depicts schematics of an exemplary implementation of the cloud computing/architecture(s) in which the exemplary inventive computer-based systems/platforms for a signal data signature detection system 100 of the present disclosure may be specifically configured to operate according to aspects of embodiments of the present disclosure.

FIG. 8 depicts schematics of an exemplary implementation of the cloud computing/architecture(s) in which the exemplary inventive computer-based systems/platforms for a signal data signature detection system 100 of the present disclosure may be specifically configured to operate according to aspects of embodiments of the present disclosure.

### DRAWINGS—REFERENCE NUMERALS

| | |
|---|---|
| 100 Signal data signature Signal data | 101 Signal data signature Recording |
| signature Detection System | |
| 102 Hardware | 103 Computer |
| 104 Memory | 105 Processor |
| 106 Network Controller | 107 Network |
| 108 Data Sources | 109 Software |
| 110 Signal data signature Detector | 111 Signal data signature Classifier |
| System | System |
| 112 Reinforcement Learning System | 113 Agent |
| 114 Action | 115 Environment |
| 116 Generative Adversarial Network | 117 Reward |
| (GAN) Discriminator | |
| 118 Signal data signature & Signal | 119 Display Screen |
| data signature Type Output | |
| 120 Paper | 200 Modified signal data signature |
| | recording |
| 201 Pool of states (signal data | 202 Function Approximator |
| signature recording, action, reward) | |
| 300 Example Actions | 301 Discriminator |
| 302 Generative Adversarial Network | 303 Generator |
| (GAN) | |
| 400 Transfer Learning | 401 RL-agent selects Action |
| 402 Neural Network Function | 403 Error Back Propagation |
| Approximator | |
| 404 Forward Propagation | |

### DETAILED DESCRIPTION

This specification describes a signal data signature detection system that includes a reinforcement learning system and a discriminator of a generative adversarial network as computer programs one or more computers in one or more locations. The signal data signature detection system components include input data, computer hardware, computer software, and output data that can be viewed by a hardware display media or paper. A hardware display media may include a hardware display screen on a device (computer, tablet, mobile phone), projector, and other types of display media.

Generally, the system performs signal data signature event detection on a signal data signature recording using a reinforcement learning system such that an agent learns a policy to identify the onset and offset timings in a signal data signature recording that result in a signal data signature distribution that the discriminator of a generative adversarial network has been trained to detect. An environment that is the signal data signature recording, an agent, a state (e.g. onset and offset tags), an action (e.g. adjusting the onset or the offset tag), and a reward (positive—net gain in minimizing cross entropy between target distribution and test distribution, negative—net loss in minimizing cross entropy between target distribution and test distribution) are the components of a reinforcement learning system. The reinforcement learning system is coupled to a real-time oracle the discriminator of a generative adversarial network such that each action (e.g. adjustment of onset or offset tags) made by an agent to the signal data signature recording results in a positive reward if the signal data signature recording has a net gain for minimizing the cross entropy between the target and test distributions or a negative reward if the signal data signature recording has a net loss for minimizing the cross entropy between the target and test distributions.

A reinforcement learning agent is learning a policy to optimize total future reward such that actions performed result in strong labeling and signal data signature type matching to the targeted signal data signature type distribution. A signal data signature type distribution has a characteristic temporal profile that the discriminator of a generative adversarial network (GAN) has been optimized to detect. Training GANs from the standpoint of game theory is similar to setting a minimax two-player game whereby both networks try to beat each other and in doing so, they both become better and better. The goal of the generator is to fool the discriminator, so the generative neural network is trained to maximize the final classification error between true and fake data. The goal of the discriminator is to detect fake generated data, so the discriminative neural network is trained to minimize the final classification error.

The reinforcement learning agent may optimize it's policy to tag the onset and offset timings such that it will match the strong-label target distribution that the discriminator was trained on as part of a GAN system. For example, the reinforcement-learning agent may be provided with a weakly labeled signal data signature recording of a bronchitis cough to learn a policy to adjust the onset and offset labels of the recording such that it matched closely to the strongly labeled distribution of bronchitis cough data that the discriminator of the GAN has been trained with. Whereas a reinforcement-learning agent provided with a weakly or strongly labeled signal data signature recording of an asthma cough may not be able to converge on a policy because the oracle or reward mechanism being the discriminator of a generative adversarial network (GAN) has been trained with a bronchitis cough dataset. The reinforcement learning agent is bound by a maximum number of iterations such that if a match is not detected within the given maximum iteration threshold a negative detection flag will be returned.

In some embodiments, the signal data signature tagging (e.g. placement of onset and offset tags) by the reinforcement learning agent may include strongly labeled signal data signature. Herein, the terms “strongly labeled”, “strong labeled”, “strong label” and/or variations thereof refer to labeling and/or labels that include temporal information. Oftentimes signal data signature recordings are weakly labeled with a presence/absence label, which only states what types of events are present in each recording without any temporal information. A reinforcement-learning agent learns a policy to identify the onset and offset timings of a signal data signature such that the signature matches the targeted strong-labeled (known onset and offset timings) distribution of a known signal data signature.

In some embodiments, the signal data signature tagging (e.g. placement of onset and offset tags) by the reinforcement learning agent may include a minimal distance window. A minimal distance window may be used to constrain an agent to maintain a set minimal distance between the onset and offset tags. A minimal distance window for example can be set by the shortest distance between onset and offset tags observed in a distribution of signal data signature events types or the distribution of a single signal data signature event as well as other distance metrics. The minimal distance window is advantageous for capturing a temporal profile of the targeted signal data signature event. Whereas as the reinforcement learning agent not constrained by a minimal distance window could learn a policy to minimize the distance between the onset and offset tags such that the signal data signature profile becomes ambiguous and loses specificity while at the same time producing a maximum reward for the agent.

In some embodiments, the signal data signature tagging (e.g. placement of onset and offset tags) by the reinforcement learning agent may include a maximum distance window. A maximum distance window may be used to constrain the search space to a maximal timing based on the signal data signature event type. A maximum distance window for example can be set by the longest distance between onset and offset tags observed in a distribution of signal data signature events types or the distribution of a single signal data signature event as well as other distance metrics that are captured from the targeted signal data signature event. The maximum distance window is advantageous for reducing computational resources and maximizing performance of the signal data signature signal data signature detection system.

In some embodiments, the signal data signature tagging (e.g. placement of onset and offset tags) by the reinforcement learning agent may include a generalizable reward mechanism, a real-time discriminator of a GAN. A real-time discriminator of a GAN when provided with a signal data signature recording, data sources (e.g. training data), computer hardware including a memory and a processor(s), and a computer program or computer programs when executed by a processor, outputs one of two values that specifies whether a particular signal data signature recording is match or not a match with the targeted signal data signature distribution.

In some embodiments, the signal data signature tagging (e.g. placement of onset and offset tags) by the reinforcement learning agent may include leveraging a transfer learning approach that combines both a generative model and a discriminative model. The discriminator of the GAN, which was trained in an adversarial environment to recognize the underlying target distribution and identify fake data, defines the generative model. The functional approximator, which could represent a feed-forward neural network, convolutional neural network, support vector machine, logistic regression, conditional random fields as well as many others, defines the discriminative model. The reinforcement-learning agent performs actions setting the timings of the onset and offset while trying to match the target distribution that the generative model was trained on. The generative model returns a positive reward for an improvement in the overlap between suggested vs. targeted distribution. The reinforcement-learning agent having accumulated experiences that are composed of signal data signature recordings (states), modifications to onset and offset (actions), net gain or net loss in overlap between distributions (rewards) exploits these experiences with a function approximator. The function approximator which is a discriminative model is then predicting which action the reinforcement learning agent should to maximize the future reward. As a consequence of the reinforcement learning agent trying to optimize a policy the discriminative model is learning from the generative model.

Advantages of a discriminative model learning from the generative model are the following 1) a generative model requires less training data, 2) a generative model can deal with missing data, 3) discriminative models may be more accurate when the conditional independence assumption is not satisfied,

The details of one or more embodiments of the subject matter of this specification are set forth in the accompanying drawings and the description below. Other features, aspects, and advantages of the subject matter will become apparent from the description, the drawings, and the claims.

### Example—Signal Data Signature Detection System

In some embodiments, a signal data signature detection system may identify whether or not the sample signal data signature distribution matches the target signal data signature distribution as well as the location of the onset and offset timings. These embodiments are advantageous for identifying signal data signature events that are captured in the wild.

In order to achieve a software program that is able, either fully or partially, to detect signal data signature events, that program matches the sample distribution to a target distribution that was used to train a generative model. Another goal of the invention is to provide strong labeling of the onset and offset timings of the sample distribution. Another challenge is that such a program must be able to scale and process large datasets.

Embodiments of the invention are directed to a signal data signature detection system whereby a signal data signature recording is provided by an individual or individuals(s) or system into a computer hardware whereby data sources and the input target distribution are stored on a storage medium and then the data sources and input target distribution are used as input to a computer program or computer programs which when executed by a processor or processor provides the strong labeled signal data signature recording and the signal data signature type which are provided to an individual or individual(s) on a display screen or printed paper.

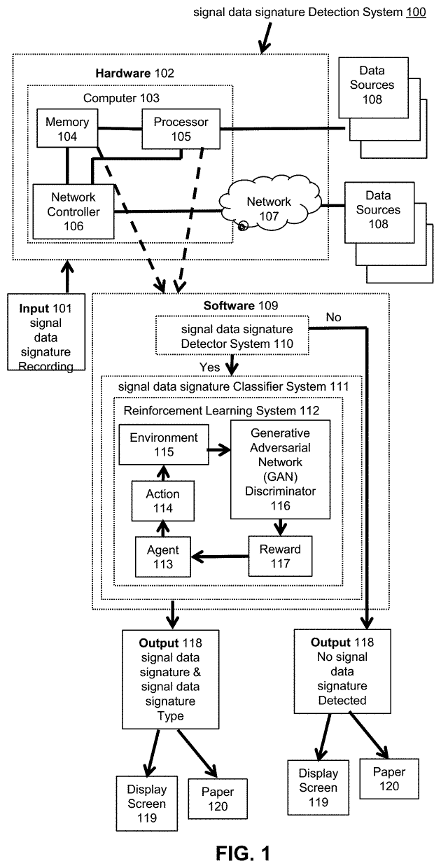

FIG. 1 illustrates a signal data signature detection system 100 with the following components: input including signal data signature recording 101, hardware device 102, software 109, and output 118. The input is a signal data signature recording such as a signal data signature recording captured by a sensor, a signal data signature recording captured on a mobile device, and a signal data signature recording captured on any other device, among others. The input including signal data signature recording 101 may be provided by an individual, individuals or a system and recorded by a hardware device 102 such as a computer 103 with a memory unit 104, processor 105 and or network controller 106. A hardware device is able to access data sources 108 via internal storage or through the network controller 106, which connects to a network 107.

The data sources 108 that are retrieved by a hardware device 102 in one of other possible embodiments includes for example but not limited to: 1) a corpus of strong labeled signal data signature recordings, 2) a corpus of weakly labeled signal data signature recordings, 3) a continuous stream of signal data signature recordings, 4) a sample signal data signature recording, 5) video recordings, 6) text related signal data signature recordings, 7) features of signal data signature recordings.

The data sources 108 and the signal data signature recording 101 input including signal data signature recording 101 are stored in memory or a memory unit 104 and passed to a software 109 such as computer program or computer programs that executes the instruction set on a processor 105. The software 109 being a computer program executes a signal data signature detector system 110 and a signal data signature classifier system 111. The signal data signature classifier system 111 executes a reinforcement learning system 112 on a processor 105 such that an agent 113 performs actions 114 on an environment 115, which calls a reinforcement learning reward mechanism, a Generative Adversarial Network (GAN) Discriminator 116, which provides a reward 117 to the system. The reinforcement learning system 112 modifies the onset and offset timings to the signal data signature recording while ensuring that the edits result in a match to the target distribution. The output 118 is either strongly labeled signal data signature recording and signal data signature type or a flag with no signal data signature detected that can be viewed by a reader on a display screen 119 or printed on paper 120.

In one or more embodiments of the signal data signature detection system 100 hardware device 102 includes the computer 103 connected to the network 107. The computer 103 is configured with one or more processors 105, a memory or memory unit 104, and one or more network controllers 106. It can be understood that the components of the computer 103 are configured and connected in such a way as to be operational so that an operating system and application programs may reside in a memory or memory unit 104 and may be executed by the processor or processors 105 and data may be transmitted or received via the network controller 106 according to instructions executed by the processor or processor(s) 105. In one embodiment, a data source 108 may be connected directly to the computer 103 and accessible to the processor 105, for example in the case of a signal data signature sensor, imaging sensor, or the like. In one embodiment, a data source 108 may be executed by the processor or processor(s) 105 and data may be transmitted or received via the network controller 106 according to instructions executed by the processor or processors 105. In one embodiment, a data source 108 may be connected to the reinforcement learning system 112 remotely via the network 107, for example in the case of media data obtained from the Internet. The configuration of the computer 103 may be that the one or more processors 105, memory unit 104, or network controllers 106 may physically reside on multiple physical components within the computer 103 or may be integrated into fewer physical components within the computer 103, without departing from the scope of the invention. In one embodiment, a plurality of computers 103 may be configured to execute some or all of the steps listed herein, such that the cumulative steps executed by the plurality of computers are in accordance with the invention.

A physical interface is provided for embodiments described in this specification and includes computer hardware and display hardware (e.g. the display screen of a mobile device). Those skilled in the art will appreciate that components described herein include computer hardware and/or executable software which is stored on a computer-readable medium for execution on appropriate computing hardware. The terms “computer-readable medium” or “machine readable medium” should be taken to include a single medium or multiple media that store one or more sets of instructions. The terms “computer-readable medium” or “machine readable medium” shall also be taken to include, but not be limited to, solid-state memories, and optical and magnetic media. For example, “computer-readable medium” or “machine readable medium” may include Compact Disc Read-Only Memory (CD-ROMs), Read-Only Memory (ROMs), Random

Access Memory (RAM), and/or Erasable Programmable Read-Only Memory (EPROM). The terms “computer-readable medium” or “machine readable medium” shall also be taken to include any non-transitory storage medium that is capable of storing, encoding or carrying a set of instructions for execution by a machine and that cause a machine to perform any one or more of the methodologies described herein. In other embodiments, some of these operations might be performed by specific hardware components that contain hardwired logic. Those operations might alternatively be performed by any combination of programmable computer components and fixed hardware circuit components.

In one or more embodiments of the signal data signature classifier system 111 software 109 includes the reinforcement learning system 112 which will be described in detail in the following section.

In one or more embodiments of the signal data signature detection system 100 the output 118 includes a strongly labeled signal data signature recording and identification of signal data signature type. An example would be cough sample from a patient which may include: 1) onset and offset timings of the signal data signature recording that capture the cough onset and offset, 2) a label of Covid-19 as the identified signal data signature type, 3) or flag that tells the user that a cough was not detected. The output 118 of strong labeled signal data signature recording and signal data signature type or message that a cough was not detected will be delivered to an end user via a display medium such as but not limited to a display screen 119 (e.g. tablet, mobile phone, computer screen) and/or paper 120.

### Example—Reinforcement Learning System

In one or more embodiments of a reinforcement learning system that performs actions within an minimal distance window of a signal data signature recording such that actions are performed on the onset and offset timings whereby, a real-time oracle reward mechanism returns a reward that is dependent on the net concordance or net discordance between the sample distribution and the target distribution. In one or more embodiments of a reinforcement learning system with a real-time oracle reward mechanism enables actions such as but not limited to adding to or reducing the onset timing while keeping the offset timing constant, or keeping the onset timing constant while adding to or reducing the offset timing, or adding to or reducing the onset timing while also adding to or reducing the offset timing.

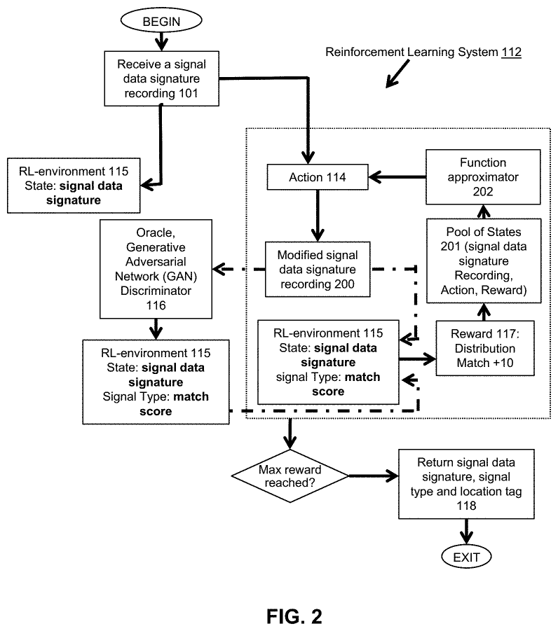

In one or more embodiments, a reinforcement learning system 112 with real-time oracle, GAN discriminator, reward mechanism is defined by an input including signal data signature recording 101, hardware device 102, software 109, and output 118. FIG. 2. illustrates an input to the reinforcement learning system 112 that may include but is not limited to a signal data signature recording 101 that is preprocessed and either modified or unmodified by another computer program or computer programs from the input including signal data signature recording 101. Another input includes data sources 108 that are provide to the oracle GAN discriminator 116 and function approximator 202 and will be described in the following sections.

In one or more embodiments, the reinforcement learning system 112 uses a hardware device 102, which consists of a memory or memory unit 104, and processor 105 such that software 109, a computer program or computer programs is executed on a processor 105 and modify the onset and offset tags of the signal data signature recording resulting in an output 118 including a strongly labeled signal data signature recording. The output from reinforcement learning system 112 is reconstructed to produce the output 118 including the strongly labeled signal data signature recording that matches a target distribution. A user is able to view the strongly labeled signal data signature recording and the output 118 including the signal data signature type output on a display screen 119 or printed paper 120.

FIG. 2 depicts a reinforcement learning system 112 with an input including signal data signature recording 101 and an environment that holds state information consisting of the signal data signature recording, and the match score; such that an agent performs actions 114 on the onset and offset labels; and an oracle GAN discriminator 116 is used as the reward mechanism returning a positive reward 117 if the modified signal data signature recording has a net gain in concordance with the target distribution and a negative reward if the modified signal data signature recording has a net loss in concordance with the target distribution. An agent receiving the signal data signature recording is able to perform actions 114 (e.g. adding to onset timing, subtracting from onset timing, adding to offset timing, subtracting from offset timing, or combination of actions) on the signal data signature recording resulting in a new modified signal data signature recording 200. The modified signal data signature recording 200 is updated in the environment and then passed to an oracle, the GAN discriminator 116 which updates the environment with a match score that specifies a signal data signature recording state (True-net gain in concordance with target distribution, False-net loss in concordance with target distribution). The GAN discriminator 116 also returns a reward 117 to the reinforcement-learning environment such that a change resulting in a net gain in concordance with the target distribution results in a positive reward and a net loss in concordance with the target distribution results in a negative reward.

In one or more embodiments, a pool of states 201 saves the state (e.g. signal data signature recording), action (e.g. adding to onset), reward (e.g. positive). After exploration and generating a large pool of states 201 a function approximator 202 is used to predict an action that will result in the greatest total reward. The reinforcement learning system 112 is thus learning a policy to perform edits to a signal data signature recording resulting in an exact match with the target distribution. One or more embodiments specify termination once a maximum reward is reached and returns the output 118 including a strongly labeled signal data signature recording and signal data signature type. Additional embodiments may have alternative termination criteria such as termination upon executing a certain number of iterations among others. Also for given input signal data signature recordings 200 it may not be possible to produce concordance with the target distribution in such instances a message will be returned that informs the user that the signal data signature was not detected.

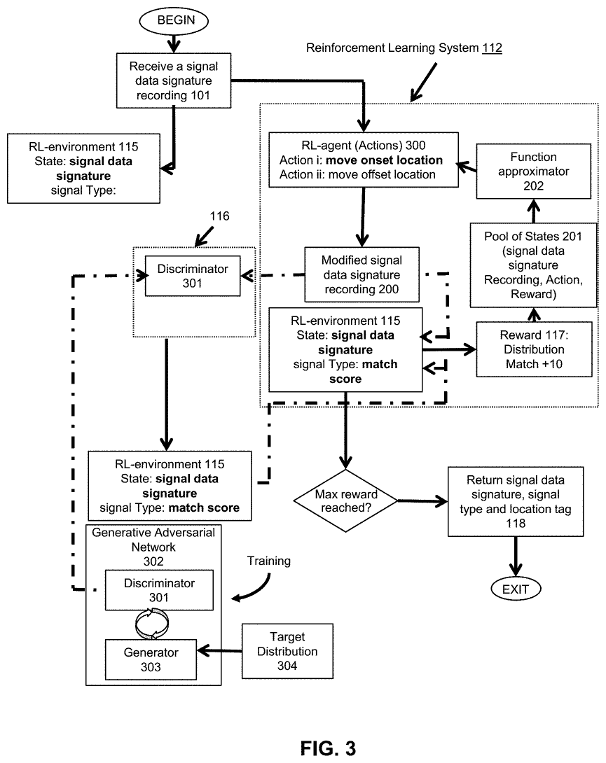

FIG. 3. Illustrates examples of actions 300 that are performed by an agent 113 to onset and offset timings within the signal data signature recording. FIG. 3 also illustrates a reinforcement learning system 112 with detailed components of the oracle, GAN discriminator 116. A discriminator 301 is trained against a generator 303 as part of a Generative Adversarial Network (GAN) 302 whereby the generator 303 is tasked with generating fake data to fool the discriminator 301 and the discriminator 301 is tasked with discriminating the fake from the real data in the input target distribution 304. The discriminator 301 trained by the GAN network is then used as a real-time oracle to decipher if the modified signal data signature recording 200 is a match to the target distribution 304 or has a net gain or net loss in concordance with the target distribution 304.

The computer program stored in memory unit 104 receives the signal data signature recording 101 and executes on a processor 105 such that the signal data signature recording is evaluated against the target distribution 304. The output of the oracle GAN discriminator 116 is either the net gain or loss of the concordance between the modified signal data signature recording and the target distribution 304 and the match score, which tells if a perfect match was found. A corresponding positive reward 117 is given for a net gain in concordance between the modified signal data signature file and the target distribution and a negative reward 117 is given for a net loss in concordance between the modified signal data signature file and the target distribution.

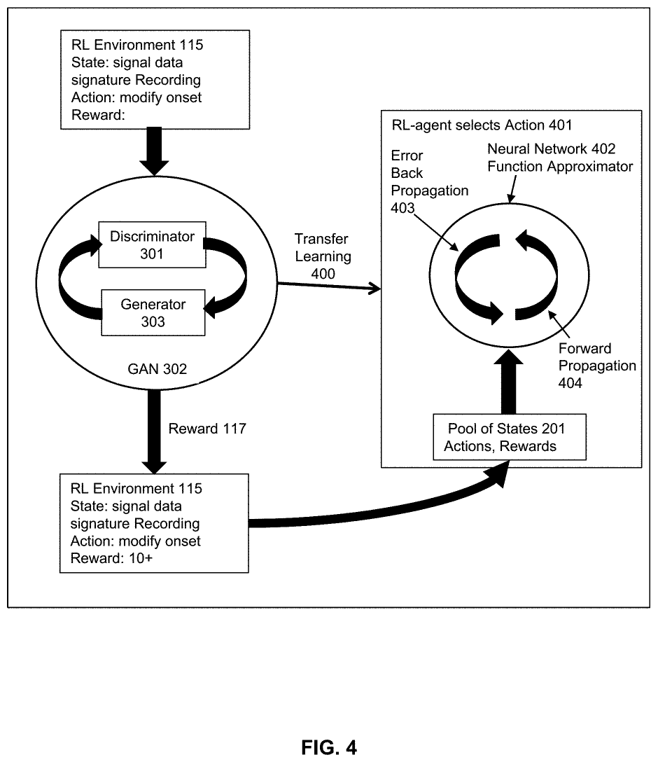

FIG. 4 illustrates a reinforcement learning system 112 with transferrable learning mechanism. The transfer learning 400 is occurring between the oracle, GAN discriminator and the function approximator (e.g. convolutional neural network CNN) that has optimized a learning policy whereby a minimal number of modifications to the onset and offset timings results in a strong label signal data signature recording. The reinforcement learning agent is performing on-policy learning whereby the agent both explores new states and exploits past experiences. The reinforcement-learning agent implementing on-policy learning is searching for the optimal policy while also acting on that same policy.

The reinforcement-learning agent selects an action 401 to maximize the total future reward. The oracle, GAN discriminator is deciding if the actions made by the RL-agent improve the concordance with the target distribution when assigning the reward. Finally, the neural network function approximator 402 maximizes the total future reward given prior experience, the pool of states, actions, and states 201. The neural network function approximator 402 trains on the pool of states, actions, and states 201, produces an estimate by forward propagation 404 and adjust its weights by back propagating the error 403 between the predicted and observed using stochastic gradient descent.

### Example—Operation Of Reinforcement Learning System

In some embodiments, an oracle, GAN discriminator evaluate the modified signal data signature recording in real-time and perform a set of actions the onset and offset timing. In this embodiment the signal data signature recording and thus its attributes (e.g. match score) represents the environment. An agent can interact with a signal data signature recording and receive a reward such that the environment and agent represent a Markov Decision Process (MDP). The MDP is a discrete time stochastic process such that at each time step the MDP represents some state s, (e.g. signal data signature recording with position of onset or offset) and the agent may choose any action a that is available in state s. The process responds at the next time step by randomly moving to a new state s′2 and passing new state s′2 residing in memory to a real-time oracle that when executed on a processor returns a corresponding reward Ra (s,s2) for s′2.

The benefits of this and other embodiments include the ability to evaluate and modify the onset and offset timings in real-time. This embodiment has application in many areas of signal data signature event detection in which a signal data signature recording needs to be identified and strongly labeled. These applications may include context-based indexing and retrieval in multimedia databases, unobtrusive monitoring in healthcare and surveillance, noise monitoring solutions, and healthcare diagnostics among others. These and other benefits of one or more aspects will become apparent from consideration of the ensuing description.

One of the embodiments provides an agent with onset and offset positions within a signal data signature recording and attributes of which include a model and actions, which can be taken by the agent. The agent is initialized with a minimum distance window for which defines the minimal distance between the onset and offset timings. The agent is also initialized with maximum distance window between the onset and offset timings, which is used as an upper limit to constrain the search space. The agent is initialized with a starting index for the onset and offset tags within the signal data signature recording.

The agent is initialized with a set of hyperparameters, which includes epsilon ε (ε=1), epsilon decay, ε_decay (ε_decay=0.999), gamma, γ (γ=0.99), and a loss rate η (η=0.001). The hyperparmeter epsilon ε is used to encourage the agent to explore random actions. The hyperparmeter epsilon ε, specifies an E-greedy policy whereby both greedy actions with an estimated greatest action value and non-greedy actions with an unknown action value are sampled. When a selected random number, r is less than epsilon ε, a random action a is selected. After each episode epsilon E is decayed by a factor ε_decay. As the time progresses epsilon ε, becomes less and as a result fewer nongreedy actions are sampled.

The hyperparmeter gamma, γ is the discount factor per future reward. The objective of an agent is to find and exploit (control) an optimal action-value function that provides the greatest return of total reward. The assumption is that future rewards should be discounted by a factor γ per time step.

The final parameter the loss rate, η is used to reduce the learning rate over time for the stochastic gradient descent optimizer. The stochastic gradient descent optimizer is used to train the convolutional neural network through back propagation. The benefits of the loss rate are to increase performance and reduce training time. Using a loss rate, large changes are made at the beginning of the training procedure when larger learning rate values are used and decreasing the learning rate such that a smaller rate and smaller training updates are made to weights later in the training procedure.

The model is used as a function approximator to estimate the action-value function, q-value. A convolutional neural network is the best mode of use. However, any other model maybe substituted with the convolutional neural network (CNN), (e.g. recurrent neural network (RNN), logistic regression model, etc.).

Non-linear function approximators, such as neural networks with weight θ make up a Q-network which can be trained by minimizing a sequence of loss functions, ᵢ(θᵢ) that change at each iteration i,

Lᵢ(θᵢ)=E_{s,a˜ρ(·)}[(yᵢ−Q(s, a; θ)²)

where

yᵢ=E_{s,a˜ρ(·);\dot{s}˜ξ}[(r+γmax_{á}Q(śá; Θᵢ₋₁)|s, a)]

is the target for iteration i and ρ s, a is a probability distribution over states s or in this embodiment signal data signature recording with onset and offset indices s. and actions a such that it represents a signal data signature recording-action distribution. The parameters from the previous iteration θ_{!} are held fixed when optimizing the loss function, L_{!}θ_{!}. Unlike the fixed targets used in supervised learning, the targets of a neural network depend on the network weights.

Taking the derivative of the loss function with respect to the weights yields,

∇_{Θ}_{ᵢ}Lᵢ(Θᵢ)=E_{a,a˜ρ(·);ś˜ξ}[(r+γmax_{á}Q(śá; Θᵢ₋₁)−Q(s, a; Θᵢ))∇_{Θ}_{ᵢ}Q(s, a; Θᵢ)]

It is computationally prohibitive to compute the full expectation in the above gradient; instead it is best to optimize the loss function by stochastic gradient descent. The Q-learning algorithm is implemented with the weights being updated after an episode, and the expectations are replaced by single samples from the signal data signature recording action distribution, (ρ s, a) and the emulator ξ.

The algorithm is model-free which means that is does not construct an estimate of the emulator ξ but rather solves the reinforcement-learning task directly using samples from the emulator ξ. It is also off-policy meaning that it follows ε-greedy policy which ensures adequate exploration of the state space while learning about the greedy policy a=max_{!}Q(s, a;θ). Another embodiment would include on-policy learning.

A CNN may be configured with a convolutional layer equal to the product of the number of features per signal data signature recording and a filter of 2, and a kernel size of 2. The filters specify the dimensionality of the output space. The kernel size specifies the length of the 1D convolutional window. One-dimensional max pooling with a pool size of 2 may be used for the max-pooling layer of the CNN. The model used the piecewise Huber loss function and adaptive learning rate optimizer, RMSprop with the loss rate, 77 hyperparameter.

After the model is initialized as an attribute of the agent, a set of actions are defined that could be taken for the boundaries of the signal data signature recording within a minimum distance window. The model is off-policy such that it randomly selects an action when the random number, r [0,1] is less than hyperparameter epsilon ε. It selects the optimal policy and returns the argmax of the q-value when the random number, r [0,1] is greater than the hyperparameter epsilon ε. After each episode epsilon ε is decayed by a factor ε_decay, a module is defined to decay epsilon ε. Finally, a module is defined to take a signal data signature features and fit a model to the signal data signature feature using a target value.

One of the embodiments provides signal data signature features such as filter bank system. The filter bank system consists of an analysis stage and synthesis stage. The analysis stage is a filter bank decomposition whereby the signal is filtered into sub-bands along with a sampling rate decimation. In the second stage, the decimated sub-band signals are interpolated to reconstruct the original signal.

Approaches to generate signal data signature features are constant-Q filter banks, Fast Fourier Transform (FFT), multiresolution spectrogram, nonuniform filter banks, wavelet filter banks, dyadic filter banks and cosine-modulated filter-bank, among others. The constant-Q filter bank includes of smoothing the output of a Fast Fourier Transform, whereas a multiresolution spectrogram combines FFTs at different lengths and advances the FFTs forward through time. The Goetzel algorithm may be used to construct nonuniform filter banks.

In some embodiments, an environment may include a current state, which is the index of onset and offset timings within the signal data signature recording that may or may not have been modified by the agent. The environment may also be provided with the match score for the current signal data signature recording and a reset state that restores the signal data signature recording to its original version before the agent performed actions. The environment is initialized with a minimum and maximum distance window.

In some embodiments, a reward module may return a negative reward r− if the modified signal data signature recording length has a net loss from the previous state's match score; and/or return a positive reward r+ the match score is a net gain from the previous state's match score. An additional positive reward r+ may be returned to the agent if the modified signal data signature recording is a perfect match with the target distribution.

At operation, a modified signal data signature recording is provided as input to a reinforcement-learning algorithm a match-score is generated in real-time from the signal data signature recording. The modified signal data signature recording and match score represents an environment. An agent is allowed to interact with the signal data signature recording and receive the reward. In the present embodiment, at operation the agent is incentivized to perform actions to the signal data signature recording that will match the strong-labeled target distribution.

First a min size, batch size, number of episodes, and number of operations are initialized in the algorithm. The algorithm then iterates over each episode from the total number of episodes; for each episode e, the signal data signature recording s, is reset from the environment reset module to the original signal data signature recording that was the input to the algorithm. The algorithm then iterates over k total number of operations; for each operation the signal data signature recording s is passed to the agent module act. A number, r is randomly selected between 0 and 1, such that if r is less than epsilon e, the total number of actions, n_{!″!#$} is defined such that n_{!″!#$}=n_{!}^{!!} where n_{!} is the number of actions and w_{!} is the positions surrounding the onset and offset in the signal data signature recording s. An action a, is randomly selected between a range of 0 and n_{!″!#$} and the action a, is returned from the agent module act.

A filter bank may be generated for the modified signal data signature recording s2 creating a computer program for which the modified signal data signature recording s2 is evaluated. If the filter bank for the modified signal data signature recording fools the discriminator of the GAN a positive bonus reward nr+ is returned otherwise a match score is calculated for the filter bank of the modified signal data signature recording and compared against the previous match score. If there is a net gain in the match score a positive reward r+ is returned otherwise a negative reward r− is returned. If k, which is iterating through the number of operations is less than the total number of operations a flag terminate is set to False otherwise set flag terminate to True. For each iteration k, append the signal data signature recording s, before action a, the reward r, the modified signal data signature recording s2 after action a, and the flag terminate to the tuple list pool. If k<number of operations repeat previous steps else call the agent module decay epsilon, e by the epsilon decay function e_decay.

Epsilon e is decayed by the epsilon decay function e_decay and epsilon e is returned. If the length of the list of tuplespool is less than the min size repeat steps previous steps again. Otherwise randomize a batch from the pool. Then for each index in the batch set the target=r, equal to the reward r for the batch at that index; generate the filter bank s2_vec for modified signal data signature recording, s2 and filter bank s_vec for the previous signal data signature recording, s. Next make model prediction X using the filter bank vector s_vec. If the terminate flag is set to False make model prediction X2 using the filter bank vector s2_vec. Using the model prediction X2 compute the q-value using the Bellman equation: q− value=r+ ymaxX_{!} and then set the target to the q-value. If the terminate flag is set to True call agent module learn and pass s_vec and target and then fit the model to the target.

The CNN is trained with weights θ to minimize the sequence of loss functions, L_{!} θ_{!} either using the target as the reward or the target as the q-value derived from Bellman equation. A greedy action a, is selected when the random number r is greater than epsilon e. The filter bank s_vec is returned for the signal data signature recording s and the model then predicts X using the filter bank s_vec and sets the q-value to X. An action is then selected as the argmax of the q-value and action a returned.

### Example—Reinforcement Learning Does Not Require Paired Datasets

The benefits of a reinforcement learning system of the software 109 as compared to a supervised learning are that it does not require large paired training datasets (e.g. on the order of 10⁹ to 10¹⁰). Reinforcement learning is a type of on-policy machine learning that balances between exploration and exploitation. Exploration is testing new things that have not been tried before to see if this leads to an improvement in the total reward. Exploitation is trying things that have worked best in the past. Supervised learning approaches are purely exploitative and only learn from retrospective paired datasets.

Supervised learning is retrospective machine learning that occurs after a collective set of known outcomes is determined. The collective set of known outcomes is referred to as paired training dataset such that a set of features is mapped to a known label. The cost of acquiring paired training datasets is substantial. For example, IBM's Canadian Hansaard corpus with a size of 10⁹ cost an estimated $100 million dollars.

In addition, supervised learning approaches are often brittle such that the performance degrades with datasets that were not present in the training data. The only solution is often reacquisition of paired datasets which can be as costly as acquiring the original paired datasets.

### Example—Real-Time Oracle, Gan Discriminator

One or more aspects includes a real-time oracle, the GAN discriminator which is trained as an adversarial network. The GAN network consists of generator and a discriminator. A generator deep neural network converts a random seed into a realistic signal data signature recording. Simultaneously, a discriminator is trained to distinguish between its output and real signal data signature recordings, which is used to produce gradient feedback to improve the generator neural network. The GAN network would be trained on recordings belonging to a particular signal data signature event such as a Covid-19 cough. In a minimax two-player game both the discriminator network and the generator network try to beat each other and in doing so, they both become better and better.

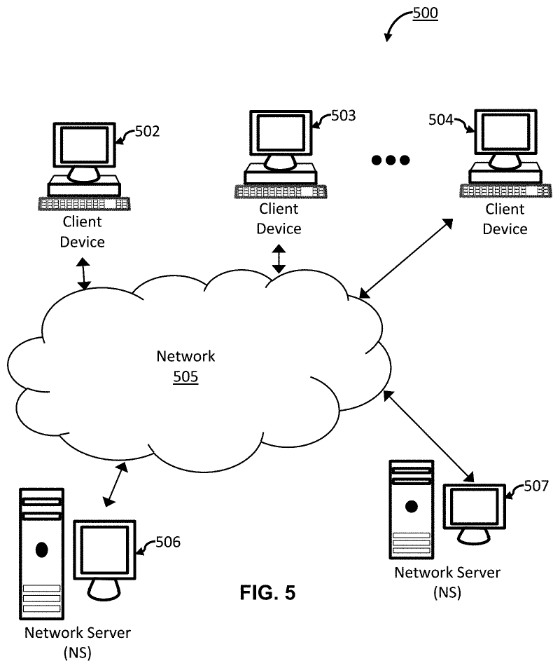

FIG. 5 depicts a block diagram of an exemplary computer-based system and platform 500 for a signal data signature detection system 100 in accordance with one or more embodiments of the present disclosure. However, not all of these components may be required to practice one or more embodiments, and variations in the arrangement and type of the components may be made without departing from the spirit or scope of various embodiments of the present disclosure. In some embodiments, the illustrative computing devices and the illustrative computing components of the exemplary computer-based system and platform 500 may be configured to manage a large number of members and concurrent transactions, as detailed herein. In some embodiments, the exemplary computer-based system and platform 500 may be based on a scalable computer and network architecture that incorporates varies strategies for assessing the data, caching, searching, and/or database connection pooling. An example of the scalable architecture is an architecture that is capable of operating multiple servers.

In some embodiments, referring to FIG. 5, member computing device 502, member computing device 503 through member computing device 504 (e.g., clients) of the exemplary computer-based system and platform 500 may include virtually any computing device capable of receiving and sending a message over a network (e.g., cloud network), such as network 505, to and from another computing device, such as servers 506 and 507, each other, and the like. In some embodiments, the member devices 502-504 may be personal computers, multiprocessor systems, microprocessor-based or programmable consumer electronics, network PCs, and the like. In some embodiments, one or more member devices within member devices 502-504 may include computing devices that typically connect using a wireless communications medium such as cell phones, smart phones, pagers, walkie talkies, radio frequency (RF) devices, infrared (IR) devices, citizens band radio, integrated devices combining one or more of the preceding devices, or virtually any mobile computing device, and the like. In some embodiments, one or more member devices within member devices 502-504 may be devices that are capable of connecting using a wired or wireless communication medium such as a PDA, POCKET PC, wearable computer, a laptop, tablet, desktop computer, a netbook, a video game device, a pager, a smart phone, an ultra-mobile personal computer (UMPC), and/or any other device that is equipped to communicate over a wired and/or wireless communication medium (e.g., NFC, RFID, NBIOT, 3G, 4G, 5G, GSM, GPRS, WiFi, WiMax, CDMA, OFDM, OFDMA, LTE, satellite, ZigBee, etc.). In some embodiments, one or more member devices within member devices 502-504 may include may run one or more applications, such as Internet browsers, mobile applications, voice calls, video games, videoconferencing, and email, among others. In some embodiments, one or more member devices within member devices 502-504 may be configured to receive and to send web pages, and the like. In some embodiments, an exemplary specifically programmed browser application of the present disclosure may be configured to receive and display graphics, text, multimedia, and the like, employing virtually any web based language, including, but not limited to Standard Generalized Markup Language (SMGL), such as HyperText Markup Language (HTML), a wireless application protocol (WAP), a Handheld Device Markup Language (HDML), such as Wireless Markup Language (WML), WMLScript, XML, JavaScript, and the like. In some embodiments, a member device within member devices 502-504 may be specifically programmed by either Java, .Net, QT, C, C++, Python, PHP and/or other suitable programming language. In some embodiment of the device software, device control may be distributed between multiple standalone applications. In some embodiments, software components/applications can be updated and redeployed remotely as individual units or as a full software suite. In some embodiments, a member device may periodically report status or send alerts over text or email. In some embodiments, a member device may contain a data recorder which is remotely downloadable by the user using network protocols such as FTP, SSH, or other file transfer mechanisms. In some embodiments, a member device may provide several levels of user interface, for example, advance user, standard user. In some embodiments, one or more member devices within member devices 502-504 may be specifically programmed include or execute an application to perform a variety of possible tasks, such as, without limitation, messaging functionality, browsing, searching, playing, streaming or displaying various forms of content, including locally stored or uploaded messages, images and/or video, and/or games.

In some embodiments, the exemplary network 505 may provide network access, data transport and/or other services to any computing device coupled to it. In some embodiments, the exemplary network 505 may include and implement at least one specialized network architecture that may be based at least in part on one or more standards set by, for example, without limitation, Global System for Mobile communication (GSM) Association, the Internet Engineering Task Force (IETF), and the Worldwide Interoperability for Microwave Access (WiMAX) forum. In some embodiments, the exemplary network 505 may implement one or more of a GSM architecture, a General Packet Radio Service (GPRS) architecture, a Universal Mobile Telecommunications System (UMTS) architecture, and an evolution of UMTS referred to as Long Term Evolution (LTE). In some embodiments, the exemplary network 505 may include and implement, as an alternative or in conjunction with one or more of the above, a WiMAX architecture defined by the WiMAX forum. In some embodiments and, optionally, in combination of any embodiment described above or below, the exemplary network 505 may also include, for instance, at least one of a local area network (LAN), a wide area network (WAN), the Internet, a virtual LAN (VLAN), an enterprise LAN, a layer 3 virtual private network (VPN), an enterprise IP network, or any combination thereof. In some embodiments and, optionally, in combination of any embodiment described above or below, at least one computer network communication over the exemplary network 505 may be transmitted based at least in part on one of more communication modes such as but not limited to: NFC, RFID, Narrow Band Internet of Things (NBIOT), ZigBee, 3G, 4G, 5G, GSM, GPRS, WiFi, WiMax, CDMA, OFDM, OFDMA, LTE, satellite and any combination thereof. In some embodiments, the exemplary network 505 may also include mass storage, such as network attached storage (NAS), a storage area network (SAN), a content delivery network (CDN) or other forms of computer or machine readable media.

In some embodiments, the exemplary server 506 or the exemplary server 507 may be a web server (or a series of servers) running a network operating system, examples of which may include but are not limited to Apache on Linux or Microsoft IIS (Internet Information Services). In some embodiments, the exemplary server 506 or the exemplary server 507 may be used for and/or provide cloud and/or network computing. Although not shown in FIG. 5, in some embodiments, the exemplary server 506 or the exemplary server 507 may have connections to external systems like email, SMS messaging, text messaging, ad content providers, etc. Any of the features of the exemplary server 506 may be also implemented in the exemplary server 507 and vice versa.

In some embodiments, one or more of the exemplary servers 506 and 507 may be specifically programmed to perform, in non-limiting example, as authentication servers, search servers, email servers, social networking services servers, Short Message Service (SMS) servers, Instant Messaging (IM) servers, Multimedia Messaging Service (MMS) servers, exchange servers, photo-sharing services servers, advertisement providing servers, financial/banking-related services servers, travel services servers, or any similarly suitable service-base servers for users of the member computing devices 501-504.

In some embodiments and, optionally, in combination of any embodiment described above or below, for example, one or more exemplary computing member devices 502-504, the exemplary server 506, and/or the exemplary server 507 may include a specifically programmed software module that may be configured to send, process, and receive information using a scripting language, a remote procedure call, an email, a tweet, Short Message Service (SMS), Multimedia Message Service (MMS), instant messaging (IM), an application programming interface, Simple Object Access Protocol (SOAP) methods, Common Object Request Broker Architecture (CORBA), HTTP (Hypertext Transfer Protocol), REST (Representational State Transfer), SOAP (Simple Object Transfer Protocol), MLLP (Minimum Lower Layer Protocol), or any combination thereof

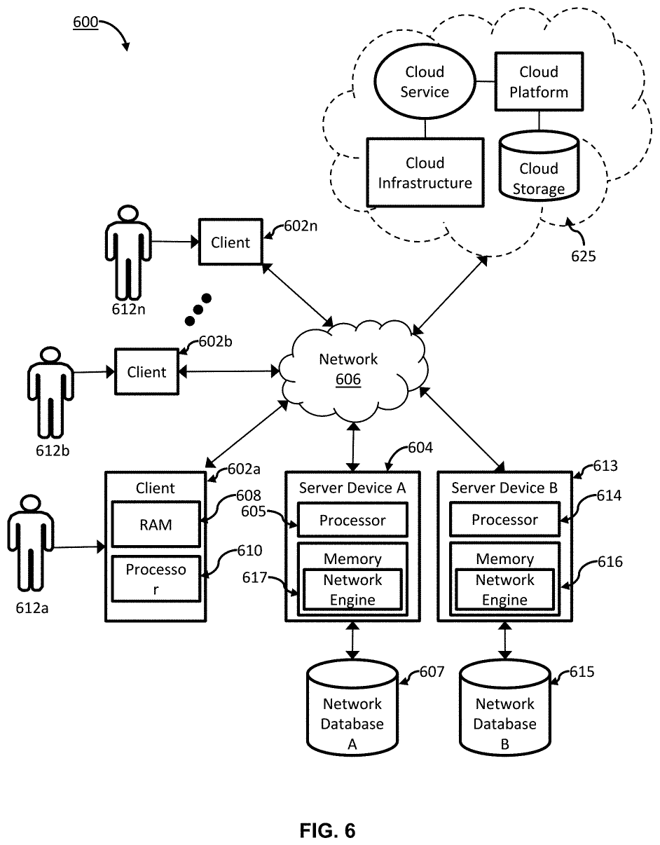

FIG. 6 depicts a block diagram of another exemplary computer-based system and platform 600 for a signal data signature detection system 100 in accordance with one or more embodiments of the present disclosure. However, not all of these components may be required to practice one or more embodiments, and variations in the arrangement and type of the components may be made without departing from the spirit or scope of various embodiments of the present disclosure. In some embodiments, the member computing device 602a, member computing device 602b through member computing device 602n shown each at least includes a computer-readable medium, such as a random-access memory (RAM) 608 coupled to a processor 610 or FLASH memory. In some embodiments, the processor 610 may execute computer-executable program instructions stored in memory 608. In some embodiments, the processor 610 may include a microprocessor, an ASIC, and/or a state machine. In some embodiments, the processor 610 may include, or may be in communication with, media, for example computer-readable media, which stores instructions that, when executed by the processor 610, may cause the processor 610 to perform one or more steps described herein. In some embodiments, examples of computer-readable media may include, but are not limited to, an electronic, optical, magnetic, or other storage or transmission device capable of providing a processor, such as the processor 610 of member computing device 602a, with computer-readable instructions. In some embodiments, other examples of suitable media may include, but are not limited to, a floppy disk, CD-ROM, DVD, magnetic disk, memory chip, ROM, RAM, an ASIC, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel, both wired and wireless. In some embodiments, the instructions may comprise code from any computer-programming language, including, for example, C, C++, Visual Basic, Java, Python, Perl, JavaScript, and etc.

In some embodiments, member computing devices 602a through 602n may also comprise a number of external or internal devices such as a mouse, a CD-ROM, DVD, a physical or virtual keyboard, a display, or other input or output devices. In some embodiments, examples of member computing devices 602a through 602n (e.g., clients) may be any type of processor-based platforms that are connected to a network 606 such as, without limitation, personal computers, digital assistants, personal digital assistants, smart phones, pagers, digital tablets, laptop computers, Internet appliances, and other processor-based devices. In some embodiments, member computing devices 602a through 602n may be specifically programmed with one or more application programs in accordance with one or more principles/methodologies detailed herein. In some embodiments, member computing devices 602a through 602n may operate on any operating system capable of supporting a browser or browser-enabled application, such as Microsoft™, Windows™ and/or Linux. In some embodiments, member computing devices 602a through 602n shown may include, for example, personal computers executing a browser application program such as Microsoft Corporation's Internet Explorer™, Apple Computer, Inc.'s Safari™, Mozilla Firefox, and/or Opera. In some embodiments, through the member computing devices 602a through 602n, user 612a, user 612b through user 612n, may communicate over the exemplary network 606 with each other and/or with other systems and/or devices coupled to the network 606. As shown in FIG. 6, exemplary server devices 604 and 613 may include processor 605 and processor 614, respectively, as well as memory 617 and memory 616, respectively. In some embodiments, the server devices 604 and 613 may be also coupled to the network 606. In some embodiments, one or more member computing devices 602a through 602n may be mobile clients.

In some embodiments, at least one database of exemplary databases 607 and 615 may be any type of database, including a database managed by a database management system (DBMS). In some embodiments, an exemplary DBMS-managed database may be specifically programmed as an engine that controls organization, storage, management, and/or retrieval of data in the respective database. In some embodiments, the exemplary DBMS-managed database may be specifically programmed to provide the ability to query, backup and replicate, enforce rules, provide security, compute, perform change and access logging, and/or automate optimization. In some embodiments, the exemplary DBMS-managed database may be chosen from Oracle database, IBM DB2, Adaptive Server Enterprise, FileMaker, Microsoft Access, Microsoft SQL Server, MySQL, PostgreSQL, and a NoSQL implementation. In some embodiments, the exemplary DBMS-managed database may be specifically programmed to define each respective schema of each database in the exemplary DBMS, according to a particular database model of the present disclosure which may include a hierarchical model, network model, relational model, object model, or some other suitable organization that may result in one or more applicable data structures that may include fields, records, files, and/or objects. In some embodiments, the exemplary DBMS-managed database may be specifically programmed to include metadata about the data that is stored.

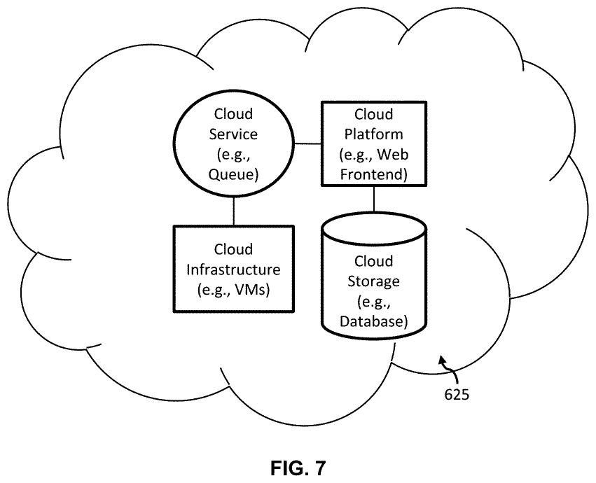

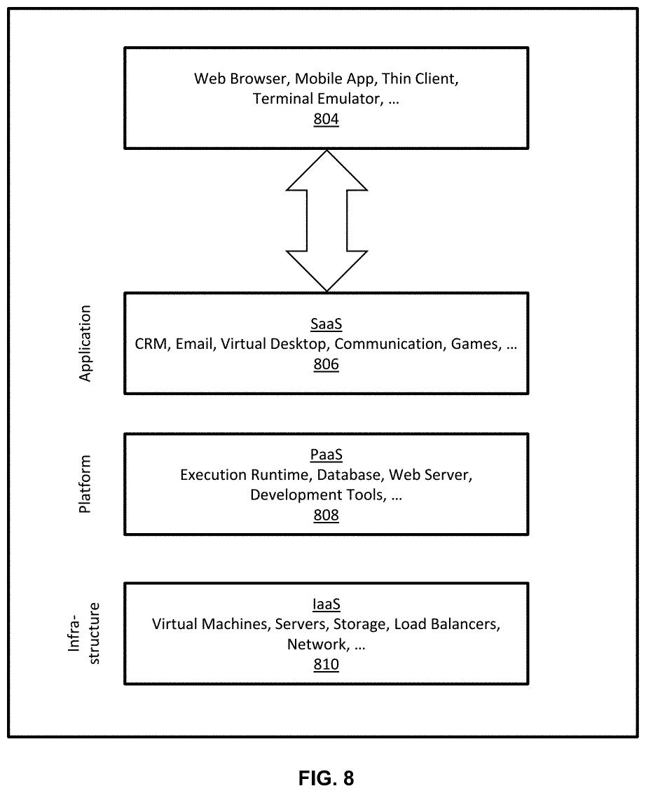

In some embodiments, the exemplary inventive computer-based systems/platforms, the exemplary inventive computer-based devices, and/or the exemplary inventive computer-based components of the present disclosure may be specifically configured to operate in a cloud computing/architecture 625 such as, but not limiting to: infrastructure a service (IaaS) 810, platform as a service (PaaS) 808, and/or software as a service (SaaS) 806 using a web browser, mobile app, thin client, terminal emulator or other endpoint 804. FIGS. 7 and 8 illustrate schematics of exemplary implementations of the cloud computing/architecture(s) in which the exemplary inventive computer-based systems/platforms for a signal data signature detection system 100 of the present disclosure may be specifically configured to operate.

It is understood that at least one aspect/functionality of various embodiments described herein can be performed in real-time and/or dynamically. As used herein, the term “real-time” is directed to an event/action that can occur instantaneously or almost instantaneously in time when another event/action has occurred. For example, the “real-time processing,” “real-time computation,” and “real-time execution” all pertain to the performance of a computation during the actual time that the related physical process (e.g., a user interacting with an application on a mobile device) occurs, in order that results of the computation can be used in guiding the physical process.

As used herein, the term “dynamically” and term “automatically,” and their logical and/or linguistic relatives and/or derivatives, mean that certain events and/or actions can be triggered and/or occur without any human intervention. In some embodiments, events and/or actions in accordance with the present disclosure can be in real-time and/or based on a predetermined periodicity of at least one of: nanosecond, several nanoseconds, millisecond, several milliseconds, second, several seconds, minute, several minutes, hourly, several hours, daily, several days, weekly, monthly, etc.

As used herein, the term “runtime” corresponds to any behavior that is dynamically determined during an execution of a software application or at least a portion of software application.

In some embodiments, exemplary inventive, specially programmed computing systems and platforms with associated devices are configured to operate in the distributed network environment, communicating with one another over one or more suitable data communication networks (e.g., the Internet, satellite, etc.) and utilizing one or more suitable data communication protocols/modes such as, without limitation, IPX/SPX, X.25, AX.25, AppleTalk™, TCP/IP (e.g., HTTP), near-field wireless communication (NFC), RFID, Narrow Band Internet of Things (NBIOT), 3G, 4G, 5G, GSM, GPRS, WiFi, WiMax, CDMA, satellite, ZigBee, and other suitable communication modes.

In some embodiments, the NFC can represent a short-range wireless communications technology in which NFC-enabled devices are “swiped,” “bumped,” “tap” or otherwise moved in close proximity to communicate. In some embodiments, the NFC could include a set of short-range wireless technologies, typically requiring a distance of 10 cm or less. In some embodiments, the NFC may operate at 13.56 MHz on ISO/IEC 18000-3 air interface and at rates ranging from 106 kbit/s to 424 kbit/s. In some embodiments, the NFC can involve an initiator and a target; the initiator actively generates an RF field that can power a passive target. In some embodiment, this can enable NFC targets to take very simple form factors such as tags, stickers, key fobs, or cards that do not require batteries. In some embodiments, the NFC's peer-to-peer communication can be conducted when a plurality of NFC-enable devices (e.g., smartphones) within close proximity of each other.

The material disclosed herein may be implemented in software or firmware or a combination of them or as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, etc.).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, programs, applications, operating system software, middleware, firmware, software modules, routines, subroutines, functions, methods, procedures, software interfaces, application program interfaces (API), instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, etc.).

In some embodiments, one or more of illustrative computer-based systems or platforms of the present disclosure may include or be incorporated, partially or entirely into at least one personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

As used herein, term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

In some embodiments, as detailed herein, one or more of the computer-based systems of the present disclosure may obtain, manipulate, transfer, store, transform, generate, and/or output any digital object and/or data unit (e.g., from inside and/or outside of a particular application) that can be in any suitable form such as, without limitation, a file, a contact, a task, an email, a message, a map, an entire application (e.g., a calculator), data points, and other suitable data. In some embodiments, as detailed herein, one or more of the computer-based systems of the present disclosure may be implemented across one or more of various computer platforms such as, but not limited to: (1) FreeBSD, NetBSD, OpenBSD; (2) Linux; (3) Microsoft Windows™; (4) OpenVMS™; (5) OS X (MacOS™); (6) UNIX™; (7) Android; (8) iOS™; (9) Embedded Linux; (10) Tizen™; (11) WebOS™; (12) Adobe AIR™; (13) Binary Runtime Environment for Wireless (BREW™); (14) Cocoa™ (API); (15) Cocoa™ Touch; (16) Java™ Platforms; (17) JavaFX™; (18) QNX™; (19) Mono; (20) Google Blink; (21) Apple WebKit; (22) Mozilla Gecko™; (23) Mozilla XUL; (24) .NET Framework; (25) Silverlight™; (26) Open Web Platform; (27) Oracle Database; (28) Qt™; (29) SAP NetWeaver™; (30) Smartface™; (31) Vexi™; (32) Kubernetes™ and (33) Windows Runtime (WinRT™) or other suitable computer platforms or any combination thereof. In some embodiments, illustrative computer-based systems or platforms of the present disclosure may be configured to utilize hardwired circuitry that may be used in place of or in combination with software instructions to implement features consistent with principles of the disclosure. Thus, implementations consistent with principles of the disclosure are not limited to any specific combination of hardware circuitry and software. For example, various embodiments may be embodied in many different ways as a software component such as, without limitation, a stand-alone software package, a combination of software packages, or it may be a software package incorporated as a “tool” in a larger software product.

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

In some embodiments, illustrative computer-based systems or platforms of the present disclosure may be configured to handle numerous concurrent users that may be, but is not limited to, at least 100 (e.g., but not limited to, 100-999), at least 1,000 (e.g., but not limited to, 1,000-9,999), at least 10,000 (e.g., but not limited to, 10,000-99,999), at least 100,000 (e.g., but not limited to, 100,000-999,999), at least 1,000,000 (e.g., but not limited to, 1,000,000-9,999,999), at least 10,000,000 (e.g., but not limited to, 10,000,000-99,999,999), at least 100,000,000 (e.g., but not limited to, 100,000,000-999,999,999), at least 1,000,000,000 (e.g., but not limited to, 1,000,000,000-999,999,999,999), and so on.

In some embodiments, illustrative computer-based systems or platforms of the present disclosure may be configured to output to distinct, specifically programmed graphical user interface implementations of the present disclosure (e.g., a desktop, a web app., etc.). In various implementations of the present disclosure, a final output may be displayed on a displaying screen which may be, without limitation, a screen of a computer, a screen of a mobile device, or the like. In various implementations, the display may be a holographic display. In various implementations, the display may be a transparent surface that may receive a visual projection. Such projections may convey various forms of information, images, or objects. For example, such projections may be a visual overlay for a mobile augmented reality (MAR) application.

In some embodiments, illustrative computer-based systems or platforms of the present disclosure may be configured to be utilized in various applications which may include, but not limited to, gaming, mobile-device games, video chats, video conferences, live video streaming, video streaming and/or augmented reality applications, mobile-device messenger applications, and others similarly suitable computer-device applications.

As used herein, the term “mobile electronic device,” or the like, may refer to any portable electronic device that may or may not be enabled with location tracking functionality (e.g., MAC address, Internet Protocol (IP) address, or the like). For example, a mobile electronic device can include, but is not limited to, a mobile phone, Personal Digital Assistant (PDA), Blackberry™, Pager, Smartphone, or any other reasonable mobile electronic device.

As used herein, terms “proximity detection,” “locating,” “location data,” “location information,” and “location tracking” refer to any form of location tracking technology or locating method that can be used to provide a location of, for example, a particular computing device, system or platform of the present disclosure and any associated computing devices, based at least in part on one or more of the following techniques and devices, without limitation: accelerometer(s), gyroscope(s), Global Positioning Systems (GPS); GPS accessed using Bluetooth™; GPS accessed using any reasonable form of wireless and non-wireless communication; WiFi™ server location data; Bluetooth™ based location data; triangulation such as, but not limited to, network based triangulation, WiFi™ server information based triangulation, Bluetooth™ server information based triangulation; Cell Identification based triangulation, Enhanced Cell Identification based triangulation, Uplink-Time difference of arrival (U-TDOA) based triangulation, Time of arrival (TOA) based triangulation, Angle of arrival (AOA) based triangulation; techniques and systems using a geographic coordinate system such as, but not limited to, longitudinal and latitudinal based, geodesic height based, Cartesian coordinates based; Radio Frequency Identification such as, but not limited to, Long range RFID, Short range RFID; using any form of RFID tag such as, but not limited to active RFID tags, passive RFID tags, battery assisted passive RFID tags; or any other reasonable way to determine location. For ease, at times the above variations are not listed or are only partially listed; this is in no way meant to be a limitation.

As used herein, terms “cloud,” “Internet cloud,” “cloud computing,” “cloud architecture,” and similar terms correspond to at least one of the following: (1) a large number of computers connected through a real-time communication network (e.g., Internet); (2) providing the ability to run a program or application on many connected computers (e.g., physical machines, virtual machines (VMs)) at the same time; (3) network-based services, which appear to be provided by real server hardware, and are in fact served up by virtual hardware (e.g., virtual servers), simulated by software running on one or more real machines (e.g., allowing to be moved around and scaled up (or down) on the fly without affecting the end user).

In some embodiments, the illustrative computer-based systems or platforms of the present disclosure may be configured to securely store and/or transmit data by utilizing one or more of encryption techniques (e.g., private/public key pair, Triple Data Encryption Standard (3DES), block cipher algorithms (e.g., IDEA, RC2, RCS, CAST and Skipjack), cryptographic hash algorithms (e.g., MD5, RIPEMD-160, RTR0, SHA-1, SHA-2, Tiger (TTH),WHIRLPOOL, RNGs).

As used herein, the term “user” shall have a meaning of at least one user. In some embodiments, the terms “user”, “subscriber” “consumer” or “customer” should be understood to refer to a user of an application or applications as described herein and/or a consumer of data supplied by a data provider. By way of example, and not limitation, the terms “user” or “subscriber” can refer to a person who receives data provided by the data or service provider over the Internet in a browser session, or can refer to an automated software application which receives the data and stores or processes the data.

The aforementioned examples are, of course, illustrative and not restrictive.

At least some aspects of the present disclosure will now be described with reference to the following numbered clauses.
1. A signal data signature detection system, comprising:
   a signal data signature recording;
   a physical hardware device consisting of a memory unit and processor;
   a software consisting of a computer program or computer programs;
   a output labeled signal data signature recording;
   a output type of the signal data signature recording;
   a display media;
   the memory unit capable of storing the signal data signature recording created by the physical interface on a temporary basis;
   the memory unit capable of storing the data sources created by the physical interface on a temporary basis;
   the memory unit capable of storing the computer program or computer programs created by the physical interface on a temporary basis;
   the processor is capable of executing the computer program or computer programs;
   wherein one or more processors; and one or more programs residing on a memory and executable by the one or more processors, the one or more programs configured to:
      provide the reinforcement learning system and the signal data signature recording and a minimum distance window which constrains the agent to only perform actions within the minimum distance window;
      provide the reinforcement learning agent with a reward function wherein the reward function uses an oracle GAN discriminator and returns a positive reward if the signal data signature recording is a match with the target distribution;
      provide the reinforcement learning agent with a reward function wherein the reward function uses an oracle GAN discriminator and returns a positive reward if there is a net gain in concordance between a modified signal data signature recording and the target distribution when compared with the previous signal data signature recording state;
      provide the reinforcement learning agent with a reward function wherein the reward function uses an oracle GAN discriminator and returns a negative reward if there is a net loss in concordance between a modified signal data signature recording and the target distribution when compared with the previous signal data signature recording state;
      provide the reinforcement learning agent with a pool of states, actions, and rewards and a function approximator wherein using the function approximator the reinforcement learning agent predicts the best action to take resulting in maximum reward;
         wherein the reinforcement learning agent optimizes a policy such the agent learns modifications to make to a onset and offset timing within the minimum distance window to match the signal data signature recording with the target distribution;
      display the output signal data signature recording with onset and offset timings on the hardware display media;
         wherein the signal data signature detection system performs edits on the signal data signature recording
         and produces the modified signal data signature recording that matches with a target signal data signature recording distribution.
2. A system comprising:
   at least one processor configured to execute software instruction, wherein the software instructions, upon execution, cause the at least one processor to perform steps to:
   receive a first state comprising:
      i) signal data signature recording;
         wherein the signal data signature recording comprises a signal data signature associated with a source of the signal data signature recording,
      ii) a first onset location within the signal data signature recording,
         wherein the first onset location comprises a beginning of the signal data signature within the signal data signature recording,
      iii) a first offset location within the signal data signature recording,
         wherein the first offset location comprises an end of the signal data signature within the signal data signature recording;
   receive a first reward associated with the first state;
   determine an action to produce a second state based on the first state, the first reward and a policy of a reinforcement learning agent, wherein the second state comprises:
      i) the signal data signature recording;
      ii) a second onset location within the signal data signature recording,
         wherein the second onset location comprises a modified beginning of the signal data signature within the signal data signature recording,
      iii) a second offset location within the signal data signature recording,
         wherein the second offset location comprises a modified end of the signal data signature within the signal data signature recording;
   utilize a discriminator machine learning model to determine a match score representative of a similarity between the second state and a target distribution of a signal data signature type;
   determine a second reward based on the match score;
   determine, based on the second reward exceeding a maximum reward threshold, a modified signal data signature recording comprising the signal data signature having the modified beginning and the modified end; and
   instruct a user device to display the modified signal data signature recording and the signal data signature type to a user to indicate a matching signal data signature type.
3. A method comprising:
   receiving, by at least one processor, a first state comprising:
      i) signal data signature recording;
         wherein the signal data signature recording comprises a signal data signature associated with a source of the signal data signature recording,
      ii) a first onset location within the signal data signature recording,
         wherein the first onset location comprises a beginning of the signal data signature within the signal data signature recording,
      iii) a first offset location within the signal data signature recording,
         wherein the first offset location comprises an end of the signal data signature within the signal data signature recording;
   receiving, by at least one processor, a first reward associated with the first state;
   determining, by at least one processor, an action to produce a second state based on the first state, the first reward and a policy of a reinforcement learning agent, wherein the second state comprises:
      i) the signal data signature recording;
      ii) a second onset location within the signal data signature recording,
         wherein the second onset location comprises a modified beginning of the signal data signature within the signal data signature recording,
      iii) a second offset location within the signal data signature recording,
         wherein the second offset location comprises a modified end of the signal data signature within the signal data signature recording;
   utilizing, by at least one processor, a discriminator machine learning model to determine a match score representative of a similarity between the second state and a target distribution of a signal data signature type;
   determining, by at least one processor, a second reward based on the match score;
   determining, based on the second reward exceeding a maximum reward threshold, by at least one processor, a modified signal data signature recording comprising the signal data signature having the modified beginning and the modified end; and
   instructing, by at least one processor, a user device to display the modified signal data signature recording and the signal data signature type to a user to indicate a matching signal data signature type.
4. A non-transitory computer readable medium having software instructions stored thereon, the software instructions configured to cause at least one processor to perform steps comprising:
   receive a first state comprising:
      i) signal data signature recording;
         wherein the signal data signature recording comprises a signal data signature associated with a source of the signal data signature recording,
      ii) a first onset location within the signal data signature recording,
         wherein the first onset location comprises a beginning of the signal data signature within the signal data signature recording,
      iii) a first offset location within the signal data signature recording,
         wherein the first offset location comprises an end of the signal data signature within the signal data signature recording;
   receive a first reward associated with the first state;
   determine an action to produce a second state based on the first state, the first reward and a policy of a reinforcement learning agent, wherein the second state comprises:
      i) the signal data signature recording;
      ii) a second onset location within the signal data signature recording,
         wherein the second onset location comprises a modified beginning of the signal data signature within the signal data signature recording,
      iii) a second offset location within the signal data signature recording,
         wherein the second offset location comprises a modified end of the signal data signature within the signal data signature recording;
   utilize a discriminator machine learning model to determine a match score representative of a similarity between the second state and a target distribution of a signal data signature type;
   determine a second reward based on the match score;
   determine, based on the second reward exceeding a maximum reward threshold, a modified signal data signature recording comprising the signal data signature having the modified beginning and the modified end; and
   instruct a user device to display the modified signal data signature recording and the signal data signature type to a user to indicate a matching signal data signature type.
5. The systems, methods and computer readable media as recited in any one or more of claims 1-4, wherein the at least one processor is further configured to execute software instructions that, upon execution, cause the at least one processor to perform steps to:
   train the discriminator machine learning model using a generator machine learning model, wherein training the discriminator machine learning model comprises:
      receiving, by the generator machine learning model, the target distribution;
      generating, by the generator machine learning model, a plurality of simulated distributions based on the target distribution;
      receiving, by the discriminator machine learning, a plurality of distributions comprising the target distribution and the plurality of simulated machine learning model;
      determining, by the discriminator machine learning model, a respective match score for each respective distribution of the plurality of distributions;
      determining, by the discriminator machine learning model, at least one matching distribution of the plurality of distributions based on the respective match score for each respective distribution of the plurality of distributions; and
      training the discriminator machine learning model based on a difference between the at least one matching distribution and the target distribution.
6. The systems, methods and computer readable media as recited in any one or more of claims 1-4, wherein the at least one processor is further configured to execute software instructions that, upon execution, cause the at least one processor to perform steps to:
   determine a net change in concordance between the second state and the target distribution based on the match score;
      wherein the net change comprises at least one of:
         a net gain in concordance, and
         a net loss in concordance; and
   determine the reward based on the net change.
7. The systems, methods and computer readable media as recited in any one or more of claims 1-4, wherein the at least one processor is further configured to execute software instructions that, upon execution, cause the at least one processor to perform steps to:
   determine a difference between the first onset location and the first offset location in the signal data signature recording; and
   determine the action as a modification to at least one of the first onset location and the second onset location that maintains the difference within a maximum window.
8. The systems, methods and computer readable media as recited in any one or more of claims 1-4, wherein the at least one processor is further configured to execute software instructions that, upon execution, cause the at least one processor to perform steps to:
   determine a difference between the first onset location and the first offset location in the signal data signature recording; and
   determine the action as a modification to at least one of the first onset location and the second onset location that maintains the difference to be greater than a minimum window.
9. The systems, methods and computer readable media as recited in any one or more of claims 1-4, wherein the at least one processor is further configured to execute software instructions that, upon execution, cause the at least one processor to perform steps to:
   utilize a function approximator machine learning model to produce an updated policy based on the first state, the action, the second state and the second reward;
      wherein the updated policy comprises at least one modified parameter of the policy.
10. The systems, methods and computer readable media as recited in claim 7, wherein the function approximator machine learning comprises a deep learning neural network.

Publications cited throughout this document are hereby incorporated by reference in their entirety. While one or more embodiments of the present disclosure have been described, it is understood that these embodiments are illustrative only, and not restrictive, and that many modifications may become apparent to those of ordinary skill in the art, including that various embodiments of the inventive methodologies, the illustrative systems and platforms, and the illustrative devices described herein can be utilized in any combination with each other. Further still, the various steps may be carried out in any desired order (and any desired steps may be added and/or any desired steps may be eliminated).

What is claimed is:

1. A system comprising:
at least one processor configured to execute software instruction, wherein the software instructions, upon execution, cause the at least one processor to perform steps to:
receive a first state comprising:
i) signal data signature recording;
wherein the signal data signature recording comprises a signal data signature associated with a source of the signal data signature recording,
ii) a first onset location within the signal data signature recording,
wherein the first onset location comprises a beginning of the signal data signature within the signal data signature recording,
iii) a first offset location within the signal data signature recording,
wherein the first offset location comprises an end of the signal data signature within the signal data signature recording;
receive a first reward associated with the first state;
determine an action to produce a second state based on the first state, the first reward and a policy of a reinforcement learning agent, wherein the second state comprises:
i) the signal data signature recording;
ii) a second onset location within the signal data signature recording,
wherein the second onset location comprises a modified beginning of the signal data signature within the signal data signature recording,
iii) a second offset location within the signal data signature recording,
wherein the second offset location comprises a modified end of the signal data signature within the signal data signature recording;
utilize a discriminator machine learning model to determine a match score representative of a similarity between the second state and a target distribution of a signal data signature type;
determine a second reward based on the match score;
determine, based on the second reward exceeding a maximum reward threshold, a modified signal data signature recording comprising the signal data signature having the modified beginning and the modified end; and
instruct a user device to display the modified signal data signature recording and the signal data signature type to a user to indicate a matching signal data signature type.

2. The system as recited in claim 1, wherein the at least one processor is further configured to execute software instructions that, upon execution, cause the at least one processor to perform steps to:
train the discriminator machine learning model using a generator machine learning model, wherein training the discriminator machine learning model comprises:
receiving, by the generator machine learning model, the target distribution;
generating, by the generator machine learning model, a plurality of simulated distributions based on the target distribution;
receiving, by the discriminator machine learning, a plurality of distributions comprising the target distribution and the plurality of simulated machine learning model;
determining, by the discriminator machine learning model, a respective match score for each respective distribution of the plurality of distributions;
determining, by the discriminator machine learning model, at least one matching distribution of the plurality of distributions based on the respective match score for each respective distribution of the plurality of distributions; and
training the discriminator machine learning model based on a difference between the at least one matching distribution and the target distribution.

3. The system as recited in claim 1, wherein the at least one processor is further configured to execute software instructions that, upon execution, cause the at least one processor to perform steps to:
determine a net change in concordance between the second state and the target distribution based on the match score;
wherein the net change comprises at least one of:
a net gain in concordance, and
a net loss in concordance; and
determine the reward based on the net change.

4. The system as recited in claim 1, wherein the at least one processor is further configured to execute software instructions that, upon execution, cause the at least one processor to perform steps to:
determine a difference between the first onset location and the first offset location in the signal data signature recording; and
determine the action as a modification to at least one of the first onset location and the second onset location that maintains the difference within a maximum window.

5. The system as recited in claim 1, wherein the at least one processor is further configured to execute software instructions that, upon execution, cause the at least one processor to perform steps to:
determine a difference between the first onset location and the first offset location in the signal data signature recording; and
determine the action as a modification to at least one of the first onset location and the second onset location that maintains the difference to be greater than a minimum window.

6. The system as recited in claim 1, wherein the at least one processor is further configured to execute software instructions that, upon execution, cause the at least one processor to perform steps to:
utilize a function approximator machine learning model to produce an updated policy based on the first state, the action, the second state and the second reward;
wherein the updated policy comprises at least one modified parameter of the policy.

7. The system as recited in claim 6, wherein the function approximator machine learning comprises a deep learning neural network.

8. A method comprising:
receiving, by at least one processor, a first state comprising:
i) signal data signature recording;
wherein the signal data signature recording comprises a signal data signature associated with a source of the signal data signature recording,
ii) a first onset location within the signal data signature recording,
wherein the first onset location comprises a beginning of the signal data signature within the signal data signature recording,
iii) a first offset location within the signal data signature recording,
wherein the first offset location comprises an end of the signal data signature within the signal data signature recording;
receiving, by at least one processor, a first reward associated with the first state;
determining, by at least one processor, an action to produce a second state based on the first state, the first reward and a policy of a reinforcement learning agent, wherein the second state comprises:
i) the signal data signature recording;
ii) a second onset location within the signal data signature recording,
wherein the second onset location comprises a modified beginning of the signal data signature within the signal data signature recording,
iii) a second offset location within the signal data signature recording,
wherein the second offset location comprises a modified end of the signal data signature within the signal data signature recording;
utilizing, by at least one processor, a discriminator machine learning model to determine a match score representative of a similarity between the second state and a target distribution of a signal data signature type;
determining, by at least one processor, a second reward based on the match score;
determining, based on the second reward exceeding a maximum reward threshold, by at least one processor, a modified signal data signature recording comprising the signal data signature having the modified beginning and the modified end; and
instructing, by at least one processor, a user device to display the modified signal data signature recording and the signal data signature type to a user to indicate a matching signal data signature type.

9. The method as recited in claim 8, further comprising:
training, by at least one processor, the discriminator machine learning model using a generator machine learning model, wherein training the discriminator machine learning model comprises:
receiving, by the generator machine learning model, the target distribution;
generating, by the generator machine learning model, a plurality of simulated distributions based on the target distribution;
receiving, by the discriminator machine learning, a plurality of distributions comprising the target distribution and the plurality of simulated machine learning model;
determining, by the discriminator machine learning model, a respective match score for each respective distribution of the plurality of distributions;
determining, by the discriminator machine learning model, at least one matching distribution of the plurality of distributions based on the respective match score for each respective distribution of the plurality of distributions; and
training the discriminator machine learning model based on a difference between the at least one matching distribution and the target distribution.

10. The method as recited in claim 8, further comprising:
determining, by at least one processor, a net change in concordance between the second state and the target distribution based on the match score;
wherein the net change comprises at least one of:
a net gain in concordance, and
a net loss in concordance; and
determining, by at least one processor, the reward based on the net change.

11. The method as recited in claim 8, further comprising:
determining, by at least one processor, a difference between the first onset location and the first offset location in the signal data signature recording; and
determining, by at least one processor, the action as a modification to at least one of the first onset location and the second onset location that maintains the difference within a maximum window.

12. The method as recited in claim 8, further comprising:
determining, by at least one processor, a difference between the first onset location and the first offset location in the signal data signature recording; and
determining, by at least one processor, the action as a modification to at least one of the first onset location and the second onset location that maintains the difference to be greater than a minimum window.

13. The method as recited in claim 8, further comprising:
determining, by at least one processor, a function approximator machine learning model to produce an updated policy based on the first state, the action, the second state and the second reward;
wherein the updated policy comprises at least one modified parameter of the policy.

14. The method as recited in claim 13, wherein the function approximator machine learning comprises a deep learning neural network.

15. A non-transitory computer readable medium having software instructions stored thereon, the software instructions configured to cause at least one processor to perform steps comprising:
receive a first state comprising:
i) signal data signature recording;
wherein the signal data signature recording comprises a signal data signature associated with a source of the signal data signature recording,
ii) a first onset location within the signal data signature recording,
wherein the first onset location comprises a beginning of the signal data signature within the signal data signature recording,
iii) a first offset location within the signal data signature recording,
wherein the first offset location comprises an end of the signal data signature within the signal data signature recording;
receive a first reward associated with the first state;
determine an action to produce a second state based on the first state, the first reward and a policy of a reinforcement learning agent, wherein the second state comprises:
i) the signal data signature recording;
ii) a second onset location within the signal data signature recording,
wherein the second onset location comprises a modified beginning of the signal data signature within the signal data signature recording,
iii) a second offset location within the signal data signature recording,
wherein the second offset location comprises a modified end of the signal data signature within the signal data signature recording;
utilize a discriminator machine learning model to determine a match score representative of a similarity between the second state and a target distribution of a signal data signature type;
determine a second reward based on the match score;
determine, based on the second reward exceeding a maximum reward threshold, a modified signal data signature recording comprising the signal data signature having the modified beginning and the modified end; and
instruct a user device to display the modified signal data signature recording and the signal data signature type to a user to indicate a matching signal data signature type.

16. The non-transitory computer readable medium as recited in claim 15, further comprising software instructions configured to cause at least one processor to perform steps comprising:
train the discriminator machine learning model using a generator machine learning model, wherein training the discriminator machine learning model comprises:
receiving, by the generator machine learning model, the target distribution;
generating, by the generator machine learning model, a plurality of simulated distributions based on the target distribution;
receiving, by the discriminator machine learning, a plurality of distributions comprising the target distribution and the plurality of simulated machine learning model;
determining, by the discriminator machine learning model, a respective match score for each respective distribution of the plurality of distributions;
determining, by the discriminator machine learning model, at least one matching distribution of the plurality of distributions based on the respective match score for each respective distribution of the plurality of distributions; and
training the discriminator machine learning model based on a difference between the at least one matching distribution and the target distribution.

17. The non-transitory computer readable medium as recited in claim 15, further comprising software instructions configured to cause at least one processor to perform steps comprising:
determine a net change in concordance between the second state and the target distribution based on the match score;
wherein the net change comprises at least one of:
a net gain in concordance, and
a net loss in concordance; and
determine the reward based on the net change.

18. The non-transitory computer readable medium as recited in claim 15, further comprising software instructions configured to cause at least one processor to perform steps comprising:
determine a difference between the first onset location and the first offset location in the signal data signature recording; and
determine the action as a modification to at least one of the first onset location and the second onset location that maintains the difference within a maximum window.

19. The non-transitory computer readable medium as recited in claim 15, further comprising software instructions configured to cause at least one processor to perform steps comprising:
determine a difference between the first onset location and the first offset location in the signal data signature recording; and
determine the action as a modification to at least one of the first onset location and the second onset location that maintains the difference to be greater than a minimum window.

20. The non-transitory computer readable medium as recited in claim 15, further comprising software instructions configured to cause at least one processor to perform steps comprising:
utilize a function approximator machine learning model to produce an updated policy based on the first state, the action, the second state and the second reward;
wherein the updated policy comprises at least one modified parameter of the policy.

21. The non-transitory computer readable medium as recited in claim 20, wherein the function approximator machine learning comprises a deep learning neural network.
